(19) United States
(12) Patent Application Publication
(10) Pub. No.: US 2024/0201136 A1
(43) Pub. Date: Jun. 20, 2024

(54) CALCULATION DEVICE AND CALCULATION METHOD

(71) Applicant: SAMSUNG ELECTRONICS CO., LTD., SUWON-SI (KR)

(72) Inventors: Koji Murata, Yokohama-shi (JP); Fumie Machida, Yokohama-shi (JP); Seunghyun Kim, Suwon-si (KR)

(21) Appl. No.: 18/506,053

(22) Filed: Nov. 9, 2023

(30) Foreign Application Priority Data
Dec. 16, 2022 (JP) 2022-200849
May 24, 2023 (KR) 10-2023-0066796

(51) Int. Cl. G01N 27/72

(52) U.S. Cl. CPC G01N 27/72

(57) ABSTRACT

A calculation device includes a calculation portion that divides a sample having a numerical solution applying portion, a connecting portion and an analytic solution applying portion into a plurality of cells, and calculates an electromagnetic field of each cell based on a physical property value associated with the cell. The calculation portion calculates the electromagnetic field of the numerical solution applying portion and the connecting portion by a numerical calculation using Maxwell's equations, Fourier transforms the calculated electromagnetic field of the connecting portion into a plane wave expressed by a wavenumber vector, sets the transformed plane wave as an initial value, calculates the a wavenumber space electromagnetic field by an analytic solution of Helmholtz's equation, when the plane wave propagates the analytic solution applying portion in the propagation direction, and calculates the electromagnetic field of the analytic solution applying portion by inverse Fourier-transforming the wavenumber space electromagnetic field.

### CROSS-REFERENCE TO RELATED APPLICATION(S)

This application claims priority under 35 U.S.C. 119 from Japanese Patent Application No. 2022-200849, filed on Dec. 16, 2022 in the Japan Patent Office, and Korean Patent Application No. 10-2023-0066796, filed on May 24, 2023 in the Korean Intellectual Property Office, the contents of both of which are herein incorporated by reference in their entireties.

### TECHNICAL FIELD

Embodiments of the present inventive concept are directed to a calculation device and a calculation method.

### DISCUSSION OF THE RELATED ART

A numerical calculation method used for optical simulation is a Finite Difference Time Domain (FDTD) method. The FDTD method divides a structure to be simulated into fine rectangular parallelepiped cells, arranges a refractive index and an electromagnetic field in each of the divided cells, and solves the discretized Maxwell's equation. The FDTD method is versatile, but a calculation speed thereof is slow. The time required for a calculation using an FDTD method is proportional to the number of aforementioned rectangular parallelepiped cells. The rectangular parallelepiped cell needs to be sufficiently smaller than a wavelength of incident light. The FDTD method requires a large number of rectangular parallelepiped cells as the structure to be simulated is large as compared with a wavelength of incident light. In recent years, progress has been made in the miniaturization and scaling-up of optical simulation objects.

### SUMMARY

Embodiments of present inventive concept provide a calculation device and a calculation method that increase a calculation speed and reduce calculation time and costs.

According to an embodiment of the present inventive concept, a calculation device includes: a calculation portion that divides a sample into a plurality of cells, and calculates an electromagnetic field of the sample by calculating an electromagnetic field of each cell based on a physical property value associated with the cell, wherein the sample includes a numerical solution applying portion, a connecting portion and an analytic solution applying portion that are sequentially arranged in a propagation direction of incident light. The calculation portion: calculates the electromagnetic field of the numerical solution applying portion and the connecting portion by a numerical calculation that uses Maxwell's equations, Fourier transforms the calculated electromagnetic field of the connecting portion into a plane wave expressed by a wavenumber vector, set the plane wave of the connecting portion as an initial value, and calculates a wavenumber space e electromagnetic field in the analytic solution applying portion using Helmholtz's equation, when the plane wave propagates the analytic solution applying portion in the propagation direction, and calculates the electromagnetic field of the analytic solution applying portion by inverse Fourier-transforming the wavenumber space electromagnetic field of the calculated analytic solution applying portion.

In the calculation device according to an embodiment, in the analytic solution applying portion, the calculation portion calculates one of an electric field, a magnetic field, or both the electric field and the magnetic field, depending on a predetermined purpose.

In the calculation device according to an embodiment, in the analytic solution applying portion, the calculation portion Fourier-transforms two of three components of the electromagnetic field, and calculates a remaining component from transverse wave conditions of electromagnetic waves.

In the calculation device according to an embodiment, in the analytic solution applying portion, the calculation portion calculates the electromagnetic field in one of a first portion that includes a predetermined plane orthogonal to the propagation direction, or a second portion sandwiched by two predetermined planes orthogonal to the propagation direction.

In the calculation device according to an embodiment, the calculation portion determines the numerical solution applying portion, the connecting portion and the analytic solution applying portion, by determining whether a complex refractive index of the cell is within a constant range in a direction opposite to the propagation direction.

In the calculation device according to an embodiment, the calculation portion calculates the electromagnetic field of the analytic solution applying portion by expanding the electromagnetic field of the connecting portion into the analytic solution applying portion using a symmetric boundary condition and an anti-symmetric boundary condition.

In the calculation device according to an embodiment, the calculation device further comprises a storage device that stores data of the electromagnetic fields of a plurality of numeral solution applying portions and a plurality of analytic solution applying portions, for a sample that includes a plurality of the numeral solution applying portions and a plurality of the analytic solution applying portions.

In the calculation device according to an embodiment, in the numeral solution applying portion and the analytic solution applying portion, a complex refractive index of the cell is within a constant range.

In the calculation device according to an embodiment, for a sample that includes a substrate and an element formed on the substrate, the calculation portion determines the analytic solution applying portion as including the substrate, the numerical solution applying portion as including the element, and the connecting portion as including a portion in the substrate to which the element is connected.

In the calculation device according to an embodiment, the numerical calculation uses at least one of an FDTD method, an FEM method, a BEM method, a CIP method, a FIT method, or a method of solving Maxwell's equations for a model in which a material is discretized with a grid.

According to an embodiment of the present inventive concept, a method for calculating an electromagnetic field of a sample includes: dividing a sample into a plurality of cells, wherein the sample includes a numerical solution applying portion, a connecting portion and an analytic solution applying portion that are sequentially arranged in a propagation direction of incident light; and calculating the electromagnetic field of the sample by calculating an electromagnetic field of each cell based on a physical property value associated with the cell. Calculating the electromagnetic field of the sample comprises: calculating the electromagnetic field of the numerical solution applying portion and the connecting portion by a numerical calculation that uses Maxwell's equations, Fourier transforming the calculated electromagnetic field of the connecting portion into a plane wave expressed by a wavenumber vector, setting the plane wave of the connecting portion as an initial value and calculating a wavenumber space electromagnetic field in the analytic solution applying portion by using Helmholtz's equation, when the plane wave propagates the analytic solution applying portion in the propagation direction, and calculating the electromagnetic field of the analytic solution applying portion by inverse Fourier-transforming the wavenumber space electromagnetic field of the calculated analytic solution applying portion.

In the calculation method according to an embodiment, calculating the electromagnetic field of the sample comprises, in the analytic solution applying portion, calculating one of an electric field, a magnetic field, or both the electric field and the magnetic field, depending on a predetermined purpose.

In the calculation method according to an embodiment, calculating the electromagnetic field of the sample comprises, in the analytic solution applying portion, Fourier-transforming two of three components of the electromagnetic field, and calculating a remaining component from transverse wave conditions of electromagnetic waves.

In the calculation method according to an embodiment, calculating the electromagnetic field of the sample comprises, in the analytic solution applying portion, calculating the electromagnetic field in one of a first portion that includes a predetermined plane orthogonal to the propagation direction, or a second portion sandwiched by two predetermined planes orthogonal to the propagation direction.

In the calculation method according to an embodiment, dividing the sample into the plurality of cells comprises determining the numerical solution applying portion, the connecting portion and the analytic solution applying portion by determining whether a complex refractive index of the cell is within a constant range in a direction opposite to the propagation direction.

In the calculation method according to an embodiment, calculating the electromagnetic field of the sample comprises calculating the electromagnetic field of the analytic solution applying portion by expanding the electromagnetic field of the connecting portion into the analytic solution applying portion using a symmetric boundary condition and an anti-symmetric boundary condition.

In the calculation method according to an embodiment, for a sample that includes a plurality of the numeral solution applying portions and a plurality of the analytic solution applying portions, the calculation method further comprises storing data of the electromagnetic fields of the plurality of numeral solution applying portions and the plurality of analytic solution applying portions.

In the calculation method according to an embodiment, in the numeral solution applying portion and the analytic solution applying portion, a complex refractive index of the cell is within a constant range.

In the calculation method according to an embodiment, for a sample that includes a substrate and an element formed on the substrate, calculating the electromagnetic field of the sample further includes determining the analytic solution applying portion as including the substrate, the numerical solution applying portion as including the element, and the connecting portion as including a portion in the substrate to which the element is connected.

In the calculation method according to an embodiment, the numerical calculation uses at least one of an FDTD method, an FEM method, a BEM method, a CIP method, a FIT method, or a method of solving Maxwell's equations for a model in which a material is discretized with a grid.

The various effects of the present inventive concept are not limited to the above, and will be more easily understood in the process of describing specific embodiments of the present inventive concept.

### BRIEF DESCRIPTION OF DRAWINGS

FIG. 1 is a perspective view of a sample according to an embodiment of the present inventive concept.

FIG. 2 is a perspective view of a plurality of cells divided from a sample according to an embodiment of the present inventive concept.

FIG. 3 is an enlarged perspective view of a cell according to an embodiment of the present inventive concept, and shows enlarged perspective view of part III of FIG. 2.

FIG. 4 is a block diagram of a calculation device according to an embodiment of the present inventive concept.

FIG. 5 is a flowchart of a calculation method of an electromagnetic field according to an embodiment of the present inventive concept.

FIG. 6 is a flowchart of a calculation method of an electromagnetic field according to an embodiment of the present inventive concept.

FIG. 7 is a flowchart of a calculation method of a numerical solution applying portion of an electromagnetic field according to an embodiment of the present inventive concept.

FIG. 8 is a graph of a complex refractive index of a numerical solution applying portion, a connecting portion and an analytic solution application portion of a sample according to an embodiment of the present inventive concept, wherein the horizontal axis represents a position of the sample in a Z-axis direction, and the vertical axis represents a complex refractive index.

FIG. 9 illustrates an X-Y plane orthogonal to a propagation direction of incident light in a sample according to an embodiment of the present inventive concept.

FIG. 10 illustrates an electromagnetic field in a first quadrant of an X-Y plane orthogonal to a propagation direction of incident light in a sample according to an embodiment of the present inventive concept, and shows an electric field Ex.

FIG. 11 illustrates an electromagnetic field in a first quadrant of an X-Y plane orthogonal to a propagation direction of incident light in a sample according to an embodiment of the present inventive concept, and shows an electric field Ey.

FIG. 12 illustrates an electromagnetic field in a first quadrant of an X-Y plane orthogonal to a propagation direction of incident light in a sample according to an embodiment of the present inventive concept, and shows an electric field Ez.

FIG. 13 illustrates an electromagnetic field of an X-Y plane orthogonal to a propagation direction of incident light in a sample according to an embodiment of the present inventive concept, and shows an electric field Ex.

FIG. 14 illustrates an electromagnetic field of an X-Y plane orthogonal to a propagation direction of incident light in a sample according to an embodiment of the present inventive concept, and shows an electric field Ey.

FIG. 15 illustrates an electromagnetic field of an X-Y plane orthogonal to a propagation direction of incident light in a sample according to an embodiment of the present inventive concept, and shows an electric field Ez.

FIG. 16 is a perspective view of a sample according to an embodiment of the present inventive concept.

FIG. 17 is a perspective view of a sample to which a calculation method according to an embodiment of the present inventive concept is applied.

FIG. 18 is a perspective view of a sample to which a calculation method according to a comparative example is applied.

FIG. 19 is a table that compares an integral value of an electric field calculated by a calculation method according to an embodiment of the present inventive concept and an integral value of an electric field calculated by a calculation method according to a comparative example.

FIG. 20 is a perspective view of a plurality of samples that have different lengths in an analytic solution applying portion in a propagation direction according to an embodiment of the present inventive concept.

FIG. 21 is a table that compares a calculation time of a calculation method according to an embodiment of the present inventive concept and a calculation time of a calculation method according to a comparative example.

FIG. 22 is a graph of a calculation time of a calculation method according to an embodiment of the present inventive concept and a calculation time of a calculation method according to a comparative example, wherein the horizontal axis represents each sample, and the vertical axis represents the calculation time.

FIG. 23 is a perspective view of a sample according to an embodiment of the present inventive concept.

FIG. 24 is a flowchart of a calculation method of an electromagnetic field according to an embodiment of the present inventive concept.

FIG. 25 is a flowchart of a calculation method of an electromagnetic field according to an embodiment of the present inventive concept.

FIG. 26 is a flowchart of a calculation method of an electromagnetic field according to an embodiment of the present inventive concept.

FIG. 27 is a flowchart of a calculation method of an electromagnetic field according to an embodiment of the present inventive concept.

### DETAILED DESCRIPTION

Hereinafter, with reference to the accompanying drawings, embodiments of the present inventive concept will be described as follows. For clarity of explanation, some of the following description may be omitted or simplified. In addition, in each drawing, the same reference numerals may be given to the same elements, and redundant descriptions may be omitted.

An overview of a calculation device and a calculation method according to embodiments of the present inventive concept will be described. A calculation device according to the embodiments of the present inventive concept is, for example, a device that calculates an electromagnetic field. The calculation device calculates the electromagnetic field using a calculation method according to embodiments of the present inventive concept. A calculation method partially applies an analytic solution in a numerical solution such as an FDTD method. First of all, an overview outline of embodiments of the present inventive concept will be described in the following sections: Application Form and Effect of Numerical Solution Method, Application Form and Target of Fourier Transform, and Solution Method and Target of Helmholtz's Equation.

### Application Form and Effect of Numerical Solution Method

For a numerical solution method according to embodiments of the present inventive concept, an FDTD method will be described as an example.

In the FDTD method, a numerical calculation can be performed by dividing a sample to be simulated for electromagnetic field analysis into fine cells. The amount of computation of the FDTD method increases in proportion to the number of cells to be used. Therefore, in an analysis method according to an embodiment of the present inventive concept, a portion can be detected in the sample where the electromagnetic field can be analytically calculated. In addition, by applying an analytic solution to the portion that can be analytically calculated, it is possible to limit the portion to which the FDTD method is applied. In other words, by reducing the number of cells to which the FDTD method is applied, the time required for numerical calculation by the FDTD method can be reduced.

### Application Form and Target of Fourier Transform

A Fourier transform according to an embodiment of the present inventive concept will be described.

First, a result of a numerical calculation by an FDTD method can be transformed into a wavenumber space by a Fourier transform with respect to real space. Next, an analytic solution can be applied to the transform result. By returning the calculated analytic solution to real space through an inverse Fourier transform, the same results as a numerical calculation by FDTD can be quickly obtained.

A Fourier transform according to an embodiment of the present inventive concept transforms an electromagnetic field in real space into that in a wavenumber space. Therefore, the Fourier transform can be performed on a predetermined portion, such as a connected portion, in a sample once at the end of an FDTD numerical calculation.

### Solution Method and Target of Helmholtz's Equation

Helmholtz's equation according to an embodiment of the present inventive concept will be described.

First, Helmholtz's equation can be applied to a portion that can be calculated analytically, and then an analytic solution of an electromagnetic field can be obtained. Helmholtz's equation can be applied to a Fourier-transformed electromagnetic field. By inverse Fourier-transforming the analytic solution, the calculation result of the electromagnetic field in real space may be obtained.

The connection between a numerical solution applying portion and an analytic solution applying portion that uses a Fourier transform is a characteristic of embodiments of the present inventive concept.

A calculation method according to an embodiment of the present inventive concept shortens the calculation time by using the characteristics of a sample to be simulated for calculation of the electromagnetic field, including optics. For example, the characteristic structure of the sample includes a structure in which an element that has a complex fine structure of approximately a size of the incident wavelength is formed on a thick silicon substrate. An electromagnetic field in the complex structure on the silicon substrate should be solved by a numerical calculation such as an FDTD method. However, the thick silicon substrate is a uniform medium. Therefore, the electromagnetic field in the thick silicon substrate can be calculated by using a plane wave expansion and an analytic solution of Helmholtz's equation.

For example, in an embodiment of the present inventive concept, an FDTD method, which is slow in a calculation speed, is limited to a portion of the sample in which complex shapes are formed, and a plane wave expansion and an analytic solution of Helmholtz's equation is applied to a uniform medium portion of the sample. Therefore, the electromagnetic field of the sample can be quickly calculated. Accordingly, the calculation speed can be increased compared to a case where the FDTD numerical calculation is applied to all regions of the sample.

For example, an analytic solution method that uses a plane wave expansion and an analytic solution of Helmholtz's equation can be faster than an FDTD numerical calculation. For this reason, letting M be defined as the number of cells in an entire sample when an FDTD method is also applied to an analytic solution applying portion in the sample, and N be defined as the number of cells when the FDTD method is limited to a portion where complex shapes are formed, the calculation time according to the FDTD method can be shortened by a factor of N/M.

Furthermore, if a convergence of an FDTD method applied to the portion where the complex shapes are formed is faster than a convergence of the FDTD method applied to a portion of a uniform media, the calculation time can be reduced by N/M times or more. Therefore, an analysis method according to an embodiment of the present inventive concept can reduce the calculation time by at least N/M times when the number of cells is defined as M and N as described above.

Next, details of a calculation device and a calculation method according to embodiments of the present inventive concept will be described. First, a sample to be calculated for an electromagnetic field will be described. In addition, a calculation device that calculates the electromagnetic field of the sample will be described, and then a calculation method that calculates the electromagnetic field of the sample will be described.

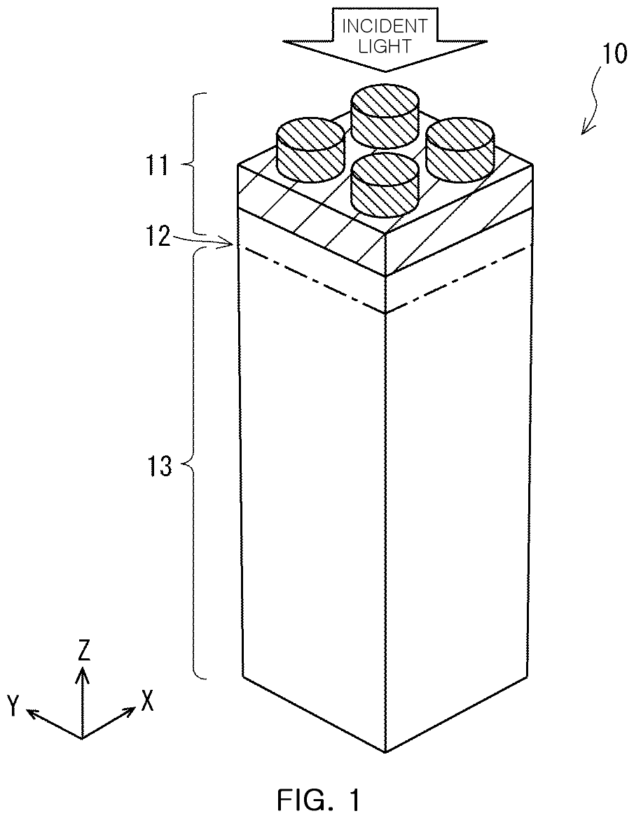

FIG. 1 is a perspective view of a sample according to an embodiment of the present inventive concept. As shown in FIG. 1, a sample 10 according to an embodiment of the present inventive concept includes a numerical solution applying portion 11, a connecting portion 12, and an analytic solution applying portion 13. Here, for convenience of description of the sample 10, an XYZ Cartesian coordinate axis system will be introduced. An optical axis of incident light incident on the sample 10 is defined as a Z-axis direction, and a plane orthogonal to the incident light is defined as an X-Y plane. The incident light propagates in a Z-axis direction. The Z-axis direction in which the incident light propagates may be defined as a propagation direction. For convenience of description, the +Z-axis direction is referred to as an upward direction, and the −Z-axis direction is referred to as a downward direction. However, the upward and downward directions are for convenience of description and do not indicate the actual arrangement directions of the sample 10.

The sample 10 includes the numerical solution applying portion 11, the connecting portion 12, and the analytic solution applying portion 13 that are sequentially disposed in the propagation direction of the incident light. For example, the numerical solution applying portion 11, the connecting portion 12, and the analytic solution applying portion 13 are arranged along the −Z-axis direction. The sample 10 includes, for example, a substrate and an element formed on the substrate. The analytic solution applying portion 13 may include the substrate. The numerical solution applying portion 11 includes the element. The connecting portion 12 includes a portion in the substrate to which the element is connected. In an embodiment of the present inventive concept, to analyze the electromagnetic field of the sample 10, the sample 10 is divided into a plurality of cells.

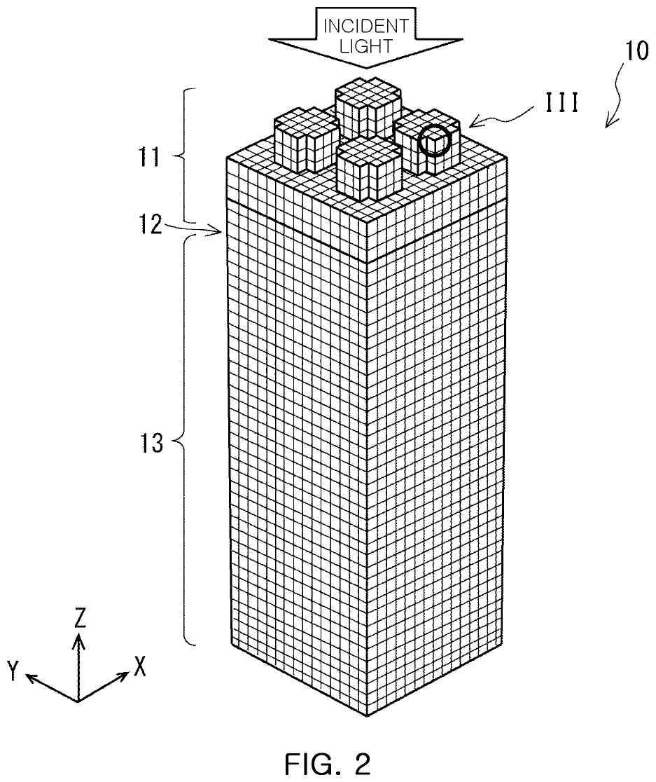

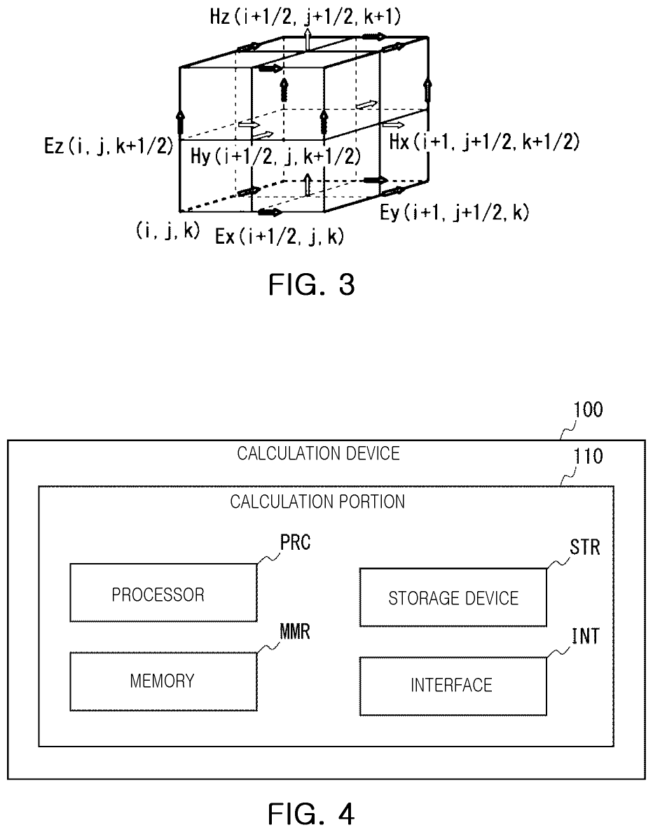

FIG. 2 is a perspective view of a plurality of cells divided from a sample according to an embodiment of the present inventive concept. FIG. 3 is an enlarged perspective view showing a cell according to an embodiment of the present inventive concept, and shows enlarged perspective view of part III of FIG. 2. As shown in FIGS. 2 and 3, the sample 10 that is to be simulated is expressed as an aggregate of a plurality of fine rectangular parallelepiped cells. A physical property value such as permittivity can be associated with each cell. An electric field E and a magnetic field H can be disposed on sides and faces of each cell. In an embodiment of the present inventive concept, the electromagnetic field of the sample 10 can be calculated by calculating the electric field E and the magnetic field H of each cell based on the physical property value associated with each cell. In the connecting portion 12 and the analytic solution applying portion 13, the incident light uniformly propagates in the propagation direction. The analytic solution applying portion 13 and the connecting portion 12 have a complex refractive index within a constant range.

Next, a calculation device will be described. FIG. 4 is a block diagram of a calculation device according to an embodiment. As shown in FIG. 4, the calculation device 100 includes a calculation portion 110. The calculation portion 110 functions as a calculation means. The calculation portion 110 sequentially divides the numerical solution applying portion 11, the connecting portion 12 and the analytic solution applying portion 13 of the sample 10 in the propagation direction of the incident light into a plurality of cells. The calculation portion 110 calculates an electromagnetic field of each cell based on a physical property value associated with each cell. Accordingly, the calculation portion 110 calculates the electromagnetic field of the sample 10.

In addition, the calculation portion 110 calculates the electromagnetic field of the numerical solution applying portion 11 and the connecting portion 12 by a numerical calculation that uses Maxwell's equations. The numerical calculation uses at least one of an FDTD method, a finite element method (FEM) method, a boundary element method (BEM) method, a cubic interpolation profile or constrained interpolation profile (CIP) method, a finite integral technique (FIT) method, or a method of solving Maxwell's equations for a model in which a material is discretized with a grid. The calculation portion 110 transforms the calculated electromagnetic field of the connecting portion 12 into a plane wave expressed by a wavenumber vector by Fourier-transforming the calculated electromagnetic field of the connection. The calculation portion 110 sets the transformed plane wave of the connecting portion 12 as an initial value, and calculates the electromagnetic field in wavenumber space of the analytic solution applying portion 13 using Helmholtz's equation when the plane wave propagates the analytic solution applying portion 13 in the propagation direction. The calculation portion 110 calculates the electromagnetic field of the analytic solution applying portion 13 in a real space by inverse Fourier-transforming the wavenumber space electromagnetic field of the calculated analytic solution applying portion 13.

The calculation device 100 may be, for example, an information processing device such as a microcomputer, a personal computer, a server, etc. The calculation device 100 includes a processor PRC, a memory MMR, a storage device STR, an interface INT, etc. The storage device STR stores programs for processes executed by each component of the calculation device 100, such as the calculation portion 110, etc. In addition, the processor PRC can read a program from the storage device STR into the memory MMR and execute the program. Accordingly, the processor PRC can realize a function of each component in the calculation device 100. The calculation device 100 shown in FIG. 4 is realized by the processor PRC executing a program that corresponds to the calculation portion 110 while referring to the memory MMR and the storage device STR.

Each component of the calculation device 100, such as the calculation portion 110, can be implemented with dedicated hardware. In addition, some or all of the components can be implemented by a general-purpose or a dedicated circuit or processor PRC, or a combination thereof. These may be implemented by a single chip, or a plurality of chips connected via a bus. Some or all of the components can be realized by a combination of the above-described circuits and programs. In addition, as the processor PRC, a central processing unit (CPU), a graphics processing unit (GPU), a field-programmable gate array (FPGA), a quantum processor (quantum computer control chip), etc., can be used.

In addition, when some or all of the components of the calculation device 100 are implemented by a plurality of information processing devices or circuits, the plurality of information processing devices or circuits can be centrally arranged or distributed. For example, the information processing devices or circuits can be implemented in a form in which each is connected via a communication network such as a client server system, a cloud computing system, etc. In addition, the functions of the calculation device 100 can be provided by software-as-a-service (SaaS).

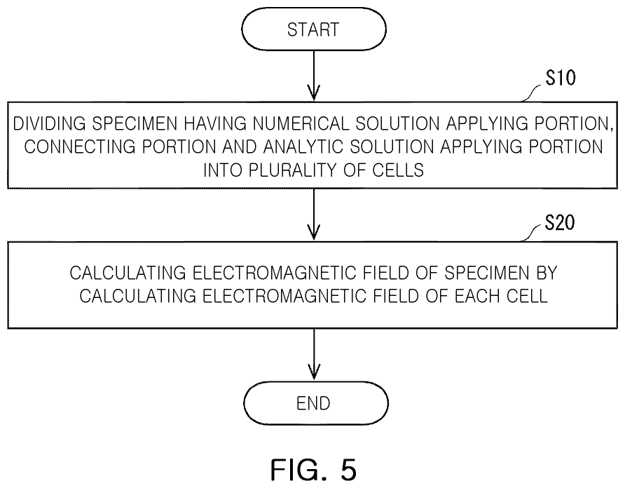

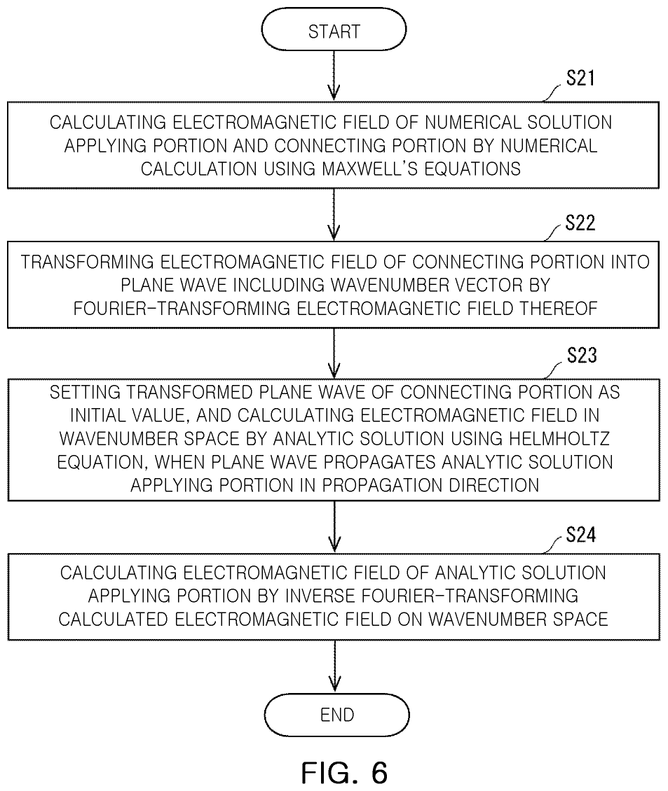

Next, a calculation method of an electromagnetic field of the sample 10 performed by the calculation portion 110 will be described. FIGS. 5 and 6 are flowcharts of calculation methods of an electromagnetic field according to Example 1. As shown in step S10 of FIG. 5, the sample 10 that sequentially has a numerical solution applying portion 11, a connecting portion 12 and an analytic solution applying portion 13 in the incident light propagation direction is divided into a plurality of cells. Next, as shown in step S20, the electromagnetic field of the sample 10 is calculated by calculating an electromagnetic field of each cell. For example, the calculation portion 110 calculates the electromagnetic field of the sample 10 by calculating the electromagnetic field of each cell based on a physical property value associated with each divided cell.

When calculating the electromagnetic field of the sample 10 in step S20, first, as shown in step S21 of FIG. 6, the electromagnetic field of the numerical solution applying portion 11 and the connecting portion 12 can be calculated by a numerical calculation that uses Maxwell's equations. The numerical calculation is, for example, at least one of an FDTD method, an FEM method, a BEM method, a CIP method, the FIT method, or a method of solving Maxwell's equations for a model in which a material is discretized with a grid. For example, the calculation portion 110 calculates the electromagnetic field of the numerical solution applying portion 11 and the connecting portion 12 by solving the electromagnetic field of each cell in the numerical solution applying portion 11 and the connecting portion 12 by the numerical calculation that uses Maxwell's equations.

Next, as shown in step S22, the calculated electromagnetic field of the connecting portion 12 is transformed into a plane wave represented by a wavenumber vector by Fourier-transforming the electromagnetic field thereof. Specifically, the calculation portion 110 transforms the electromagnetic field of each cell of the connecting portion 12 into a plane wave in wavenumber space by Fourier-transforming the electromagnetic field thereof.

Next, as shown in step S23, the transformed plane wave of the connecting portion 12 is set as an initial value, and the wavenumber space electromagnetic field of the analytic solution applying portion 13 is calculated by an analytic solution using Helmholtz's equation, when the plane wave propagates the analytic solution applying portion 13 in the propagation direction. For example, the calculation portion 110 calculates an analytic solution in the wavenumber space using Helmholtz's equation with the transformed plane wave as an initial value.

Next, as shown in step S24, the electromagnetic field of the analytic solution applying portion 13 is calculated by inverse Fourier-transforming the calculated wavenumber space electromagnetic field. Hereinafter, a calculation method of the electromagnetic field of each of the numerical solution applying portion 11, the connecting portion 12, and the analytic solution applying portion 13 in the sample 10 will be described.

The numerical solution applying portion 11 includes a complex structure of the sample 10. For example, the numerical solution applying portion 11 includes an element formed on a substrate and that has a fine structure of approximately the size of the incident wavelength. The numerical solution applying portion 11 performs an electromagnetic field analysis by a numerical calculation. The numerical calculation includes, for example, an FDTD calculation. On the other hand, the numerical calculation is not limited to the FDTD calculation, and may be calculated by at least one of an FDTD method, an FEM method, a BEM method, a CIP method, an FIT method, or a method of solving Maxwell's equations for a model in which a material is discretized with a grid.

An analysis method according to an embodiment of the present inventive concept analyzes the electromagnetic field of the numerical solution applying portion 11 by solving an electric field and a magnetic field of each cell in the numerical solution applying portion 11 by a numerical calculation that uses Maxwell's equations. For example, an analysis method according to an embodiment of the present inventive concept analyzes the electromagnetic field by numerically solving Maxwell's equations for the numerical solution applying portion 11 in a time domain. For example, Equations 1 and 2 of Maxwell's Equations, below, can be solved by an FDTD method to obtain a steady-state solution. Here, E denotes a strength of the electric field, H denotes a strength of the magnetic field, D denotes an electric flux density, B denotes a magnetic flux density, and J denotes a current density. The incident light from a light source is given by the current density J:

$$∇ \times H = \frac{\partial D}{\partial t} + J \qquad Equation 1$$

$$∇ \times E = - \frac{\partial B}{\partial t} \qquad Equation 2$$

For example, when the sample 10 includes a substrate and an element, such as a semiconductor element, formed on the substrate and that has a fine structure of approximately the size of the incident wavelength, the calculation portion 110 selects a portion that includes the semiconductor element as the numerical solution applying portion 11. The calculation portion 110 reads physical property parameter values needed to calculate the electric field E and the magnetic field H of each cell in the selected numerical solution applying portion 11. The calculation portion 110 continues to update the electromagnetic field by the FDTD numerical calculation that uses the Maxwell's equations until the electromagnetic field in the selected numerical solution applying portion 11 is in a steady state.

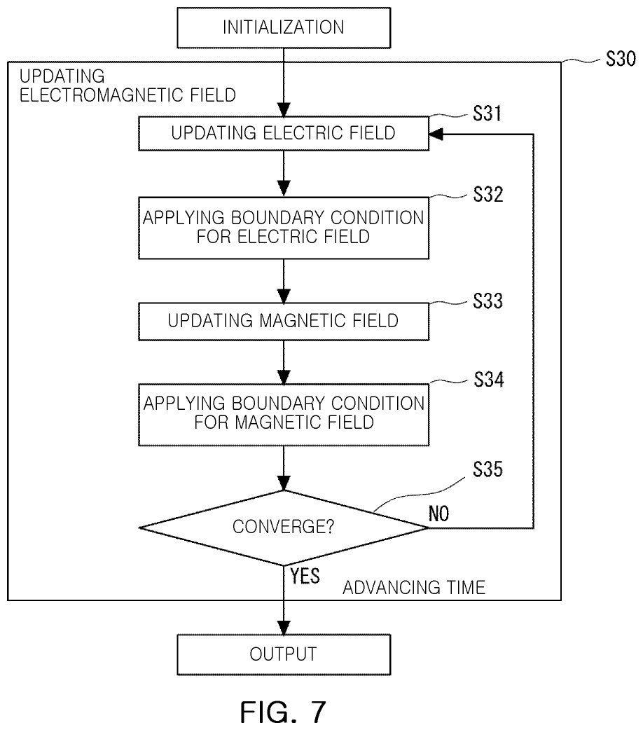

FIG. 7 is a flowchart of a calculation method of a numerical solution applying portion 11 in an electromagnetic field calculation method according to an embodiment of the present inventive concept. As shown in step S30 of FIG. 7, in a calculation method according to an embodiment of the present inventive concept, a calculation method for the numerical solution applying portion 11 includes updating the electromagnetic field. For example, the electromagnetic field is updated in time using Maxwell's equations.

For example, as shown in step S31, the electric field E is updated. As shown in step S32, a boundary condition for the electric field E is applied. As shown in step S33, the magnetic field H is updated. As shown in step S34, a boundary condition for the magnetic field H is applied. Then, as shown in step S35, convergence is determined. In step S35, if convergence does not occur, the method returns to step S31, and repeats steps S31 to S35. In step S35, if convergence occurs, a calculation result is output. Equations 3 and 4, below, are examples of updated equations for the electric field (E) and the magnetic field (H):

$$E ( t ) = E ( t - Δ t ) + \frac{1}{ε Δ t} ( ∇ \times H ( t - \frac{Δ t}{2} ) - J ) \qquad Equation 3$$

$$H ( t + \frac{Δ t}{2} ) = H ( t - \frac{Δ t}{2} ) - ∇ \times E ( t ) \qquad Equation 4$$

If time advances by Δt, the current J is t-Δt of the next step. By repeating this, the electromagnetic field propagates in time within the sample 10. Equations 3 and 4, above, are the updated equations of the electromagnetic field in a lossless dielectric medium. For lossy or dispersive media, they are more complex equations. Since Equations 3 and 4 are applied to all rectangular parallelepiped cells, the calculation time increases in proportion to the number of cells.

The connecting portion 12 is located between the numerical solution applying portion 11 and the analytic solution applying portion 13. For example, the connecting portion 12 includes a portion of a bottom surface of the numerical solution applying portion 11 on the analytic solution applying portion 13 side. The connecting portion 12 and the analytic solution applying portion 13 are portions through which the incident light uniformly propagates in the propagation direction. For example, a complex refractive index of each cell in the connecting portion 12 and the analytic solution applying portion 13 includes a portion within a constant range. The term ‘constant’ includes values that are not only strictly constant, but also constant within a range withing unavoidable measurement errors. When the sample 10 includes a substrate and an element formed on the substrate and that has a fine structure of approximately the size of the incident wavelength, the connecting portion 12 includes an upper surface of the substrate to which the element is connected. The calculation portion 110 numerically calculates the electromagnetic field of the connecting portion 12.

A calculation method of the electromagnetic field according to an embodiment of the present inventive concept analyzes the electromagnetic field of the connecting portion 12 by solving the electric field E and magnetic field H of each cell in the connecting portion 12 by a numerical calculation that uses Maxwell's equations. For example, in a calculation method according to an embodiment of the present inventive concept, the electromagnetic field is calculated by numerically solving the Maxwell's equations for the connecting portion 12 in a time domain.

In addition, in a calculation method according to an embodiment of the present inventive concept, the calculated electric field E and magnetic field H of each cell of the connecting portion 12 are Fourier transformed into a plane wave in the wavenumber space. Then, an analytic solution in the wavenumber space is calculated using Helmholtz's equation with the transformed plane wave as an initial value. The calculated analytic solution is used to calculate the electromagnetic field of the analytic solution applying portion 13.

For example, the calculation portion 110 calculates the electromagnetic field of the connecting portion 12 as follows. The calculation portion 110 Fourier-transforms the electromagnetic field that was calculated by, for example, an FDTD numerical calculation in the connecting portion 12 from an X-Y plane to a kx-ky plane in wavenumber space. The calculation portion 110 applies an analytic solution of Helmholtz's equation by expanding an arbitrary electromagnetic field distribution in the connecting portion 12 into a plane wave.

For example, the calculation portion 110 Fourier-transforms the electromagnetic field distribution of the connecting portion 12 calculated by the FDTD method in the X-Y plane, and expands the analytic solution to an applicable plane wave. This is set as an initial value when solving Helmholtz's equation. Next, the calculation portion 110 generates wavenumber space cells in the analytic solution of Helmholtz's equation. When a fast Fourier transform is used as the Fourier transform, the cells on the X-Y plane need to be evenly distributed, so generation of equal cells and electromagnetic fields of those cells can be prepared by interpolation, etc.

The analytic solution applying portion 13 is below the connecting portion 12. When the sample 10 includes a substrate and an element formed on the substrate and has a fine structure of approximately the size of the incident wavelength, the analytic solution applying portion 13 includes a portion of the substrate.

A calculation method of the electromagnetic field of the analytic solution applying portion 13 is as follows. The calculation portion 110 Fourier-transforms the electric field E and the magnetic field H of each cell of the connecting portion 12 into a plane wave in a wavenumber space. Then, the wavenumber space electromagnetic field of the analytic solution applying portion 13 is calculated using Helmholtz's equation with the transformed plane wave as an initial value. For example, the calculation portion 110 calculates an analytic solution of Helmholtz's equation by assuming that the plane wave propagates through the analytic solution applying portion 13 in the propagation direction. The analytic solution is analytically calculated. The calculated analytic solution includes the electromagnetic field of the analytic solution applying portion 13 in wavenumber space. Then, the calculating unit 110 calculates the electromagnetic field of the analytic solution applying portion 13 in a real space by inverse Fourier-transforming the calculated analytic solution, that is, the electromagnetic field in the wavenumber space.

The calculation portion 110 can rapidly calculate the electromagnetic field of the substrate, such as a silicon substrate, as the analytic solution of Helmholtz's equation in wavenumber space using the plane wave in the connecting portion 12 as an initial value. A plane wave that propagates in a uniform medium is an analytic solution of Helmholtz's equation as shown in Equation 5 below:

$$( {∇}^{2} + {n}^{2} {k}_{0}^{2} ) E = 0 \qquad Equation 5$$

When the electromagnetic field is in a steady state, the solution of Helmholtz's equation can be obtained as shown in Equations 6 and 7 below:

$$( \frac{{\partial }^{2}}{\partial {x}^{2}} + \frac{{\partial }^{2}}{\partial {y}^{2}} + \frac{{\partial }^{2}}{\partial {z}^{2}} + {n}^{2} {k}_{0}^{2} ) E = 0 \qquad Equation 6$$

$$\frac{{\partial }^{2} E ( x , y , z )}{\partial {z}^{2}} = - ( \frac{{\partial }^{2}}{\partial {x}^{2}} + \frac{{\partial }^{2}}{\partial {y}^{2}} + {n}^{2} {k}_{0}^{2} ) E ( x , y , z ) \qquad Equation 7$$

Since the optical axis of the incident light is in the Z-axis direction, when the electromagnetic field is Fourier-transformed in the X-Y plane, it is a plane wave expressed by a wavenumber vector (kx, ky). Since these are expressed as exp[−i(kxX+kyY+kzZ)], the above equation can be converted as shown in Equations 8 to 11 below:

$$\frac{{\partial }^{2} {E}^{k} ( {k}_{x} , {k}_{y} , {k}_{z} )}{\partial {z}^{2}} = ( {k}_{x}^{2} + {k}_{y}^{2} - {n}^{2} {k}_{0}^{2} ) {E}^{k} ( {k}_{x} , {k}_{y} , {k}_{z} ) \qquad Equation 8$$

$$\frac{{\partial }^{2} {E}^{k} ( {k}_{x} , {k}_{y} , {k}_{z} )}{\partial {z}^{2}} = ( {k}_{x}^{2} + {k}_{y}^{2} - {n}^{2} {k}_{0}^{2} ) {E}^{k} ( {k}_{x} , {k}_{y} , {k}_{z} ) \qquad Equation 9$$

$${E}^{k} ( {k}_{x} , {k}_{y} , z + Δ z ) = {e}^{- i {k}_{z} ( z + Δ z )} {E}^{k} ( {k}_{x} , {k}_{y} ) = {e}^{- i {k}_{z} z} {e}^{- i {k}_{z} Δ z} {E}^{k} ( {k}_{x} , {k}_{y} ) \qquad Equation 10$$

$$∴ {E}^{k} ( {k}_{x} , {k}_{y} , z + Δ z ) = {e}^{- i {k}_{z} Δ z} {E}^{k} ( {k}_{x} , {k}_{y} , z ) \qquad Equation 11$$

Using the electromagnetic field at the connecting portion 12 obtained by an FDTD method, etc., as an initial value, Equation 11 can be solved in the Z-axis direction, and the result thereof can be returned to real space by an inverse Fourier transform thereof. Accordingly, the calculation portion 110 can rapidly obtain the result of the electromagnetic field of the analytic solution applying portion 13 as the same result as that calculated by an FDTD method.

For example, the flow of the calculation is shown by an electric field (E), but the same method can be applied to the magnetic field (H), and each calculation can be independently obtained. Therefore, in the analytic solution applying portion 13, the calculation portion 110 of an embodiment calculates one of the electric field E, the magnetic field H, or both the electric field E and the magnetic field H, depending on a predetermined purpose. Accordingly, a calculation amount and a memory usage for the analytic solution applying portion 13 can be effectively reduced or managed.

In addition, since the Fourier-transformed electromagnetic wave is a plane wave, its respective components are orthogonal to each other in a propagation direction. Therefore, transverse wave conditions according to Equations 12 and 13 below can be established:

$$k \cdot E = {k}_{x} {E}_{x} + {k}_{y} {E}_{y} + {k}_{z} {E}_{z} = 0 \qquad Equation 12$$

$$k \cdot H = {k}_{x} {H}_{x} + {k}_{y} {H}_{y} + {k}_{z} {H}_{z} = 0 \qquad Equation 13$$

In the analytic solution applying portion 13, the calculation portion 110 Fourier-transforms two of the three components of the electric field E, and calculates the remaining component from the transverse wave conditions of electromagnetic waves. For example, only Ex and Ey are Fourier-transformed to apply the analytic solution, and based on the result, Ez is calculated without a Fourier transform as shown in Equation 14 below:

$${E}_{z} = - \frac{{k}_{x} {E}_{x} + {k}_{y} {E}_{y}}{{k}_{z}} \qquad Equation 14$$

The same method can be used for the magnetic field (H). Therefore, in the analytic solution applying portion 13, the calculation portion 110 Fourier-transforms two of the three components of the electromagnetic field, and calculates the remaining component from transverse wave conditions of the electromagnetic waves. By using this feature, when the structure of the sample 10 is large in the traverse direction, that is, in the X-axis direction or the Y-axis direction, a calculation time and a memory usage required for the Fourier transform can be effectively reduced.

In addition, in Equation 11, there may be no particular limitations on a magnitude of a value of ΔZ. If the electromagnetic field of the connecting portion 12 that connects the numerical solution applying portion 11 that includes the complex structure and the analytic solution applying portion 13 of the uniform medium can be calculated, the electromagnetic field can be obtained for any X-Y plane in the analytic solution portion 13. Accordingly, in the analytic solution applying portion 13, the calculation portion 110 analyzes the electromagnetic field in one of a portion that includes a predetermined plane orthogonal to the propagation direction or a portion sandwiched by two predetermined planes orthogonal to the propagation direction. For example, when an electromagnetic field at a deep portion of the substrate in the sample is required, no calculations are required for unnecessary portions, and therefore, a calculation time and a memory usage can be reduced.

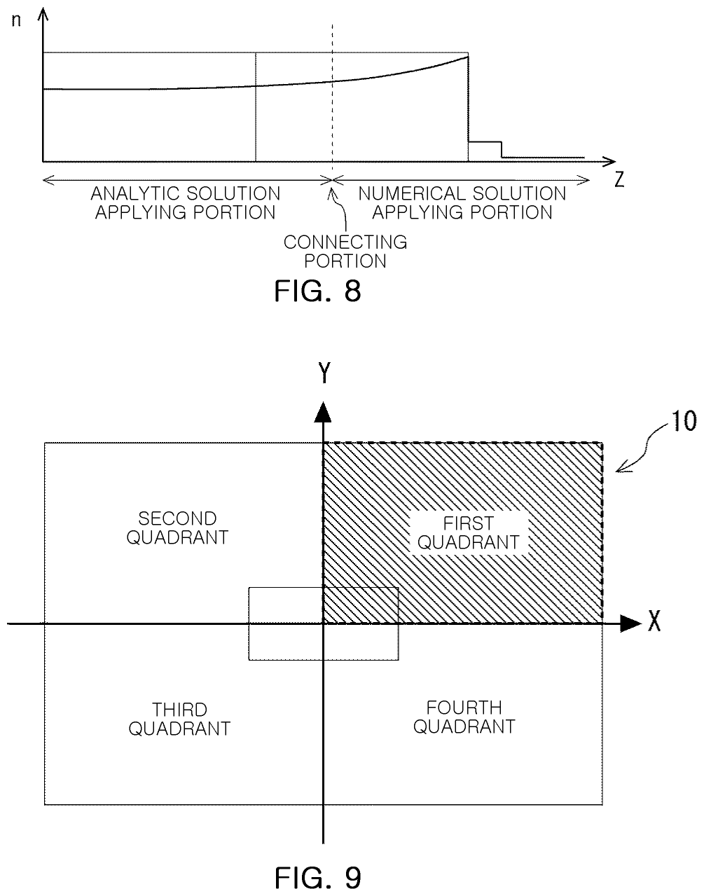

FIG. 8 is a graph of a complex refractive index of a numerical solution applying portion 11, a connecting portion 12 and an analytic solution application portion 13 of a sample 10 according to an embodiment of the present inventive concept, where the horizontal axis represents a position of the sample 10 in a Z-axis direction, and the vertical axis represents the complex refractive index. As shown in FIG. 8, the calculation portion 110 determines the numerical solution applying portion 11, the connecting portion 12 and the analytic solution applying portion 13 by determining whether a complex refractive index of the cell is within a constant range in a direction opposite to the propagation direction.

The calculation portion 110 sets conditions for a medium to be considered as a uniform medium in advance. For example, the calculation portion 110 determines that the medium is uniform when the complex refractive index thereof is within a constant range. The calculation portion 110 determines the complex refractive index in the direction opposite to the propagation direction of the incident light. When the complex refractive index of a portion of the sample 10 smoothly changes within a constant range, the calculation portion 110 determines this portion as the analytic solution applying portion 13. When a complex refractive index of a portion of sample 10 is out of a constant range, the calculation portion 110 determines this portion as the connecting portion 12. The calculation portion 110 determines the portion in a direction opposite to the connecting portion 12 as the numerical solution applying portion 11. For example, the calculation portion 110 automatically determines the numerical solution applying portion 11, the connecting portion 12, and the analytic solution applying portion 13 by scanning/determining in a direction opposite to the propagation direction of the incident light. For example, a complex refractive index of a material occupied by the i, j, and k-th cell can be represented as shown in Equation 15 below, where i, j, and k are cell numbers in the X, Y, and Z-axis directions, respectively:

$${\tilde{n}}_{ijk} \qquad Equation 15$$

If a reflectance of a bottom-most cell of the structure is less than a set threshold value, the structure can be regarded as a uniform medium. For example, the reflectance can be expressed as Equations 16 and 17 below:

$${r}_{ijk} := \vert \frac{{\tilde{n}}_{ijk} - {\tilde{n}}_{000}}{{\tilde{n}}_{ijk} + {\tilde{n}}_{000}} \vert < {ε}_{threshold} ⇒ \tilde{n} = const \qquad Equation 16$$

$$( \tilde{n} := n + i κ ) \qquad Equation 17$$

FIG. 9 illustrates an X-Y plane orthogonal to a propagation direction of the incident light in the sample 10 according to an embodiment of the present inventive concept. As shown in FIG. 9, when the structure of the sample 10 is symmetric with respect to the propagation direction of the incident light and the incident light is also symmetric with respect to the propagation direction, the electromagnetic field is also symmetric. For this reason, by calculating the electromagnetic field in a first quadrant, the distribution of the electromagnetic field of the entire sample 10 in second to fourth quadrants can be calculated.

In the numerical solution applying portion 11, when both the structure of the sample 10 and intensity of the incident light are symmetric with respect to the propagation direction, a symmetric boundary condition and an anti-symmetric boundary condition may be used. In an embodiment of the present inventive concept, the calculation portion 110 calculates the electromagnetic field of the connecting portion 12 between the numerical solution applying portion 11 and the analytic solution applying portion 13 by using a Fourier transformed plane wave expansion of the electromagnetic field. For example, to use the Fourier transformed plane wave expansion of the electromagnetic field, the distribution of the electromagnetic field should be periodic. However, the analytic solution applying portion 13 is a uniform medium. Therefore, if the electromagnetic field of the first quadrant can be calculated, the original periodic electromagnetic field can be reproduced by appropriately inverting and/or copying the electromagnetic field of the first quadrant into the second to fourth quadrants, which are omitted due to symmetry. In this way, the calculation portion 110 according to an embodiment of the present inventive concept can calculate the analytic solution applying portion 13 using the symmetric boundary conditions and the anti-symmetric boundary conditions.

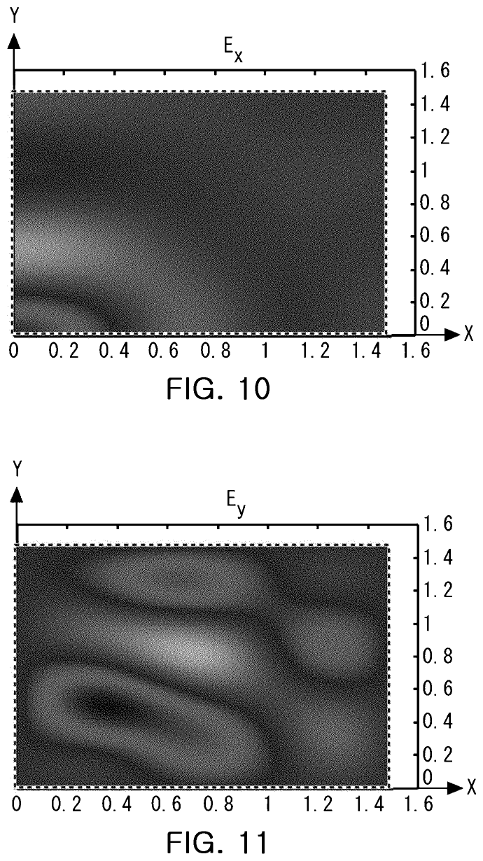

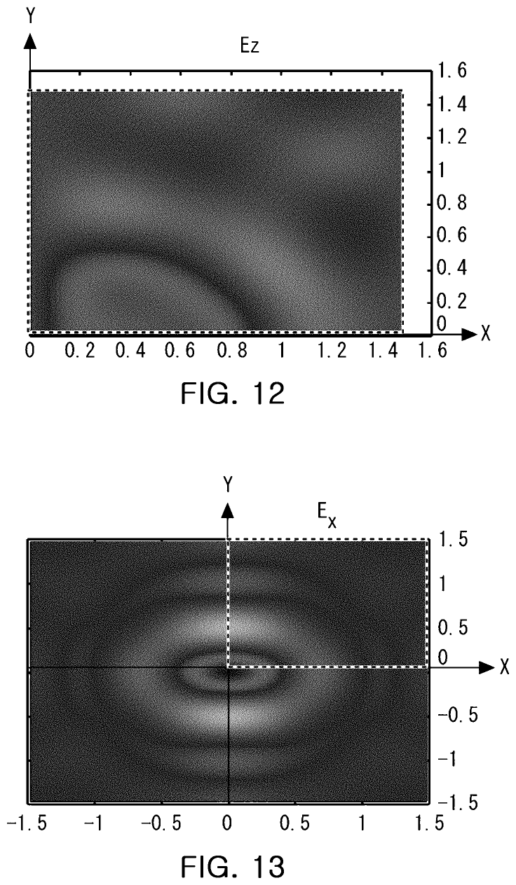

FIGS. 10 to 12 illustrate the electromagnetic field in the first quadrant of the X-Y plane orthogonal to the propagation direction of the incident light in the sample 10 according to an embodiment of the present inventive concept. FIG. 10 shows the electric field Ex, FIG. 11 shows the electric field Ey, and FIG. 12 shows the electric field Ez. As shown in FIGS. 10 to 12, the electromagnetic field obtained for the first quadrant might not be periodic.

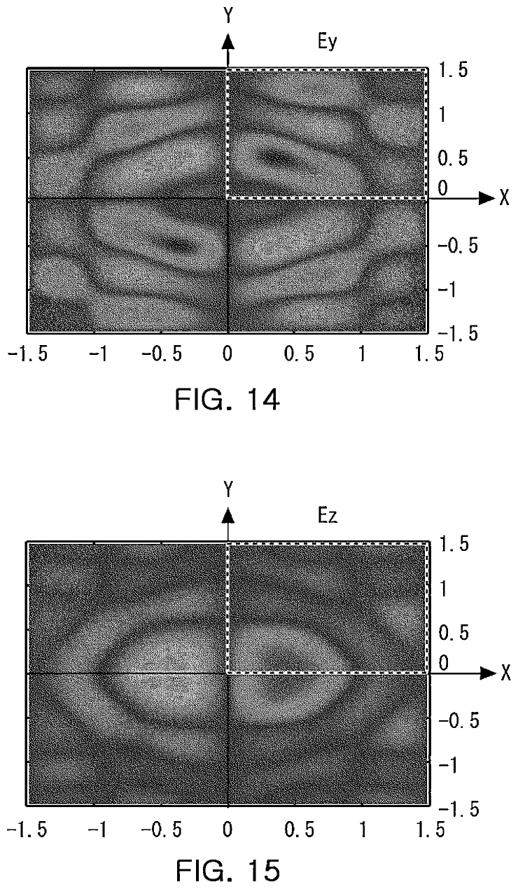

FIGS. 13 to 15 illustrate the electromagnetic field of the X-Y plane orthogonal to the propagation direction of the incident light in the sample 10 according to an embodiment of the present inventive concept. FIG. 13 shows the electric field Ex, FIG. 14 shows the electric field Ey, and FIG. 15 shows the electric field Ez. As shown in FIGS. 13 to 15, the original electromagnetic field can be reproduced by expanding, inverting and/or copying the regions of FIGS. 10 to 12. For example, the calculation portion 110 can calculate the electromagnetic field of the analytic solution applying portion 13 by expanding the electromagnetic field at the connecting portion 12 to the analytic solution applying portion 13 using a symmetric boundary condition and an anti-symmetric boundary condition. For example, only an X component of the electric field E of the incident light may be non-zero. The X component in the internal electric field E of the sample 10 may be symmetric in the X-axis direction and the Y-axis direction. A Y component may be anti-symmetric in the X-axis direction and the Y-axis direction, and a Z component may be anti-symmetric and symmetric in the X-axis direction and the Y-axis direction, respectively.

The calculation portion 110 Fourier-transforms the reproduced electromagnetic field and applies the analytic solution of Helmholtz's equation. The electromagnetic field in the first quadrant obtained in this way is the same as when a numerical calculation method is applied to the entire region.

For example, a calculation method of an embodiment includes a portion of analytically calculating Helmholtz's equation for the electromagnetic field in wavenumber space. Since the analytic calculation is faster than the FDTD numerical calculation, the calculation of the electromagnetic field in the entire sample 10 is accelerated.

The same result as the FDTD method can be obtained by calculating the analytic solution on the entire substrate and returning it to real space by an inverse Fourier transform. For example, by inverse Fourier-transforming the wavenumber space electromagnetic field, the real space electromagnetic field can be calculated for a substrate such as a silicon substrate.

Next, effects according to an embodiment of the present inventive concept will be described. In a calculation device and a calculation method according to an embodiment of the present inventive concept, the sample 10 is divided into the numerical solution applying portion 11, the connecting portion 12, and the analytic solution applying portion 13. Therefore, the calculation speed can be increased and the calculation time cost can be reduced.

Here, a case in which the electromagnetic field is calculated by numerically treating the entire sample 10 as the numerical solution applying portion 11, and a case in which the electromagnetic field is calculated by dividing the sample 10 into the numerical solution applying portion 11, the connecting portion 12, and the analytic solution applying portion 13, will be compared. Hereinafter, an example in which the entire sample 10 is numerically calculated will be referred to as a comparative example.

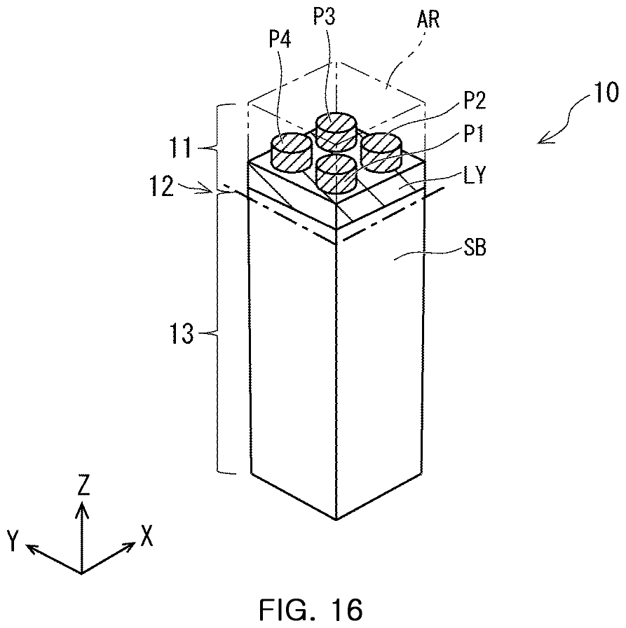

FIG. 16 is a perspective view of a sample 10 according to an embodiment of the present inventive concept. As shown in FIG. 16, the sample 10 includes a layer portion LY, post portions P1 to P4, a space portion AR and a substrate portion SB. With respect to the sample 10, an integral value of the electric field in each region obtained by causing the incident light to enter from an upper portion of the sample 10 is compared for the present embodiment and the comparative example.

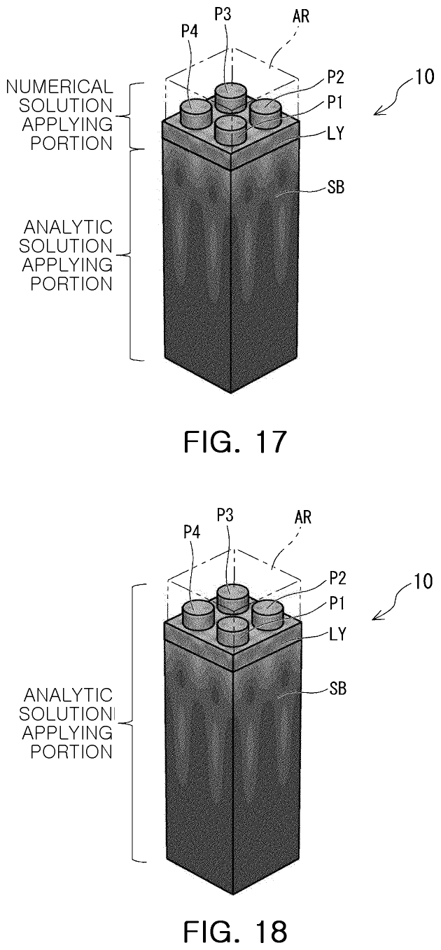

FIG. 17 is a perspective view of a sample 10 to which a calculation method according to an inventive example of the present inventive concept is applied. FIG. 18 is a perspective view of a sample 10 to which a calculation method according to a comparative example is applied. As shown in FIG. 17, in a calculation method of an inventive example of the present inventive concept, the layer portion LY, the post portions P1 to P4 and the space portion AR other than the substrate portion SB are the numerical solution applying portion 11, and the substrate portion SB is the analytic solution applying portion 13. On the other hand, as shown in FIG. 18, in a calculation method of a comparative example, the layer portion LY, the post portions P1 to P4, the space portion AR, and the substrate portion SB are the numerical solution applying portion 11.

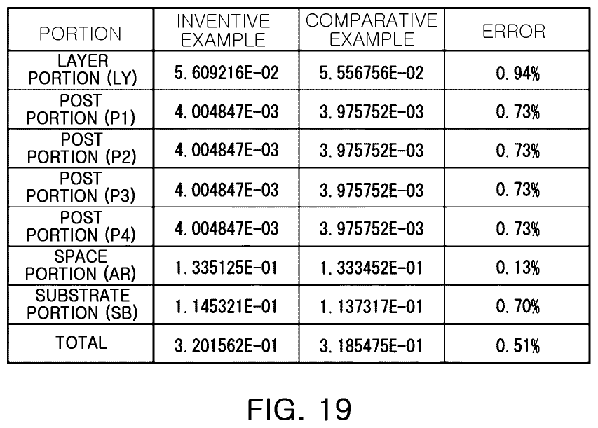

FIG. 19 is a table that compares an integral value of an electric field calculated by a calculation method according to an inventive example of the present inventive concept and an integral value of an electric field calculated by a calculation method according to a comparative example. As shown in FIG. 19, the error between the value according to the inventive example and the value according to the comparative example is less than 1% in each portion. Therefore, a calculation method according to an embodiment of the present inventive concept can prevent a decrease in calculation accuracy of the electromagnetic field. In general, since an FDTD method is a difference method, it can contain numerical errors when an electromagnetic field propagates. In addition, when an absorption boundary condition is applied, erroneous reflection from an end of the analytic solution applying portion 13 can be included. However, when applying an analytic solution, errors due to such a numerical calculation are not included. For this reason, a calculation method according to an embodiment of the present inventive concept can increase the calculation accuracy more than a calculation method of the comparative example.

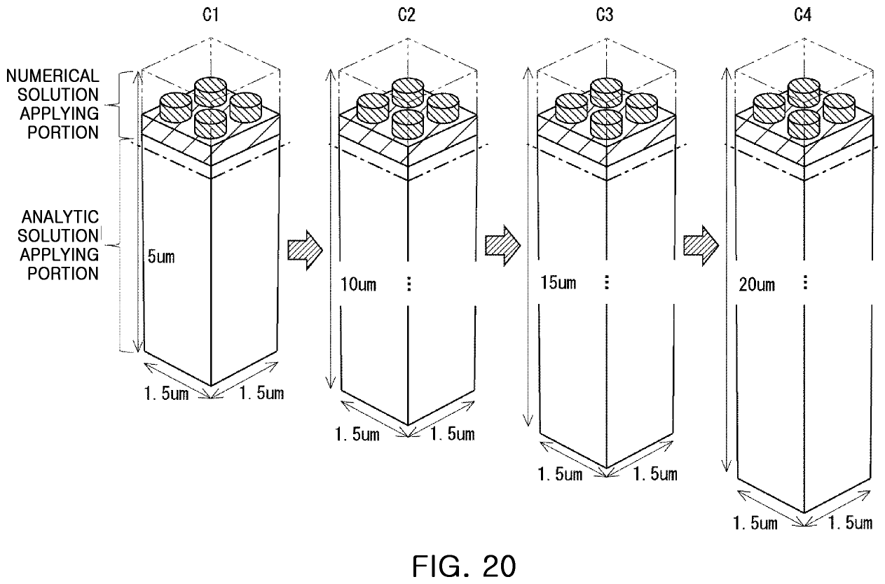

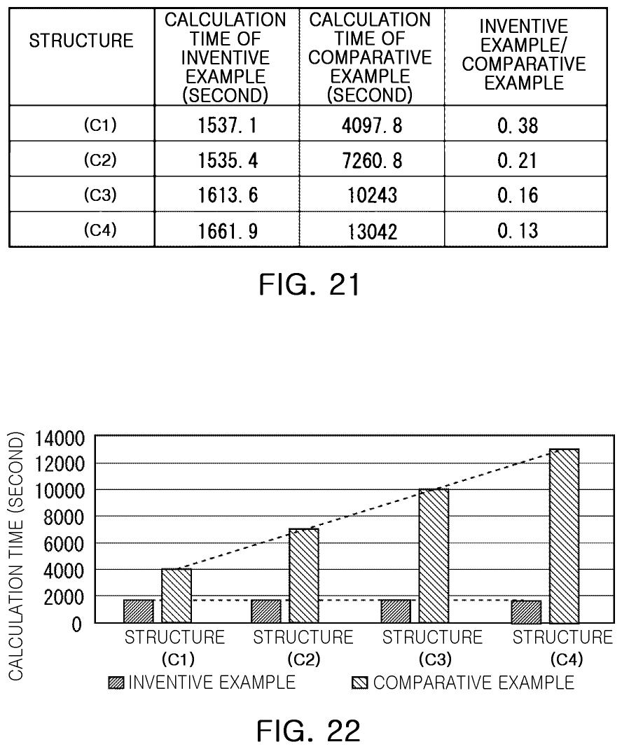

FIG. 20 is a perspective view of a plurality of samples 10 that have different lengths in a propagation direction of the analytic solution applying portion 13 according to an inventive example of the present inventive concept. FIG. 21 is a table that compares a calculation time of a calculation method according to an inventive example of the present inventive concept and a calculation time of a calculation method according to a comparative example. FIG. 22 is a graph that compares a calculation time of a calculation method according to an inventive example of the present inventive concept and a calculation time of a calculation method according to a comparative example, where the horizontal axis represents each sample, and the vertical axis represents the calculation time.

As shown in FIG. 20, with respect to structures C1 to C4, in which a thickness of the substrate portion SB, i.e., the analytic solution applying portion 13 of the sample 10, changes, the calculation time of a calculation method according to the inventive example of the present inventive concept and the calculation time of a calculation method according to a comparative example are compared. As shown in FIGS. 21 and 22, in the calculation method of the comparative example, the calculation time increases in proportion to the thickness of the substrate portion SB. However, in a calculation method according to the inventive examples of the present inventive concept, regardless of the thickness of the substrate portion SB, the calculation speed does not substantially increase. Therefore, a calculation method according to an embodiment of the present inventive concept can shorten the calculation time when the analytic solution applying portion 13 is larger than the numerical solution applying portion 11.

In the calculation method of the comparative example, when an FDTD method is applied to the entire sample 10, the time until the electromagnetic field becomes saturated, for example, the time required for convergence, will be defined as T seconds in the numerical solution applying portion 11, and will be defined as S seconds in the analytic solution applying portion 13. When the relationship between these calculation times is T>S, the convergence time in the numerical solution applying portion 11 of the inventive example of the present inventive concept and the comparative example do not differ. Therefore, the calculation time can be reduced by simply reducing the number of cells. However, when T<S, the calculation method according to the inventive example of the present inventive concept replaces the slowly converging calculation of the electromagnetic field of the substrate portion with a faster method that uses an analytic solution. For this reason, in a calculation method according to an embodiment of the present inventive concept, the convergence of the electromagnetic field itself can be accelerated, and the calculation time can be also reduced by simply reducing the number of cells. Therefore, an analysis method according to an embodiment of the present inventive concept can reduce the calculation time proportional to the reduction of the number of cells.

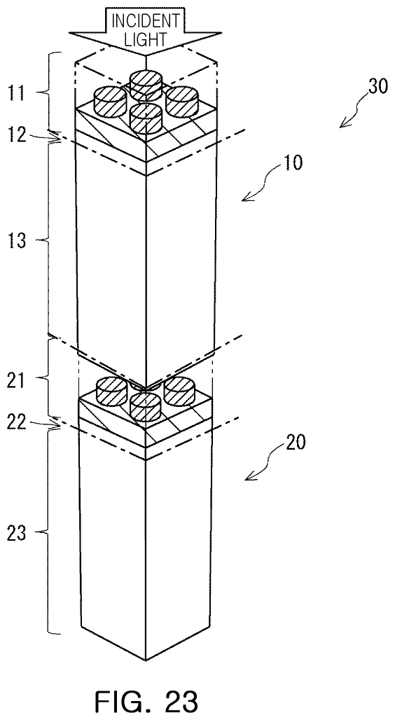

Next, an embodiment of the present inventive concept will be described with reference to FIG. 23, etc. An embodiment of the present inventive concept is a case that includes a plurality of at least one of the numerical solution applying portion 11 and the analytic solution applying portion 13. FIG. 23 is a perspective view of a sample according to an embodiment of the present inventive concept. As shown in FIG. 23, the sample 30 according to an embodiment of the present inventive concept has a structure that includes, for example, two samples 10 and 20 stacked in the propagation direction of the incident light. Accordingly, the sample 30 includes two numerical solution applying portions 11 and 21, two connecting portions 12 and 22, and two analytic solution applying portions 13 and 23.

For example, in the analytic solution applying portion 13 sandwiched between the numerical solution applying portion 11 and the numerical solution applying portion 21, both of a transmitted wave from the numerical solution applying portion 11 and a reflected wave from the numerical solution applying portion 21 may be present. For this reason, a calculation in one direction might not be complete. Accordingly, the calculation portion 110 calculates multiple reflections. In addition, the calculation device 100 includes a storage device STR that stores values of an electromagnetic field. The storage device STR stores data of the electromagnetic fields of the plurality of numerical solution applying portions 11 and 21 and the plurality of analytic solution applying portions 13 and 23. With this configuration, the calculation portion 110 can obtain a calculation result equivalent to that in the case where an FDTD method is applied to the entire sample 30.

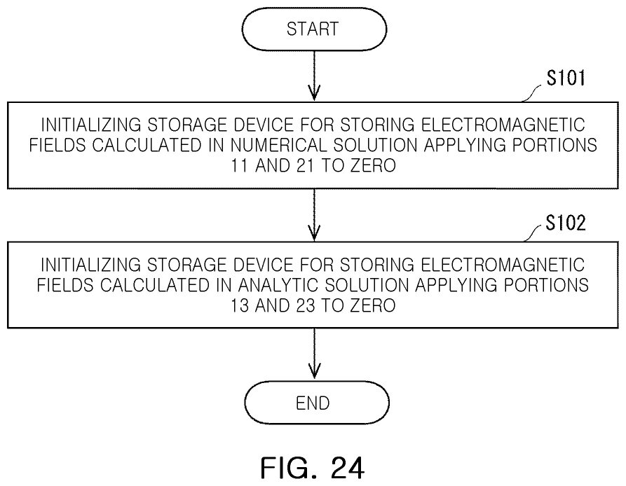

FIGS. 24 to 27 are flowcharts of calculation methods of an electromagnetic field according to embodiments of the present inventive concept. As shown in step S101 of FIG. 24, a predetermined portion of the storage device STR that separately stores the electromagnetic fields calculated in the numerical solution applying portions 11 and 21 is initialized to zero. Next, as shown in step S102, a predetermined portion of the storage device STR that separately stores the electromagnetic fields calculated in the analytic solution applying portions 13 and 23 is initialized to zero.

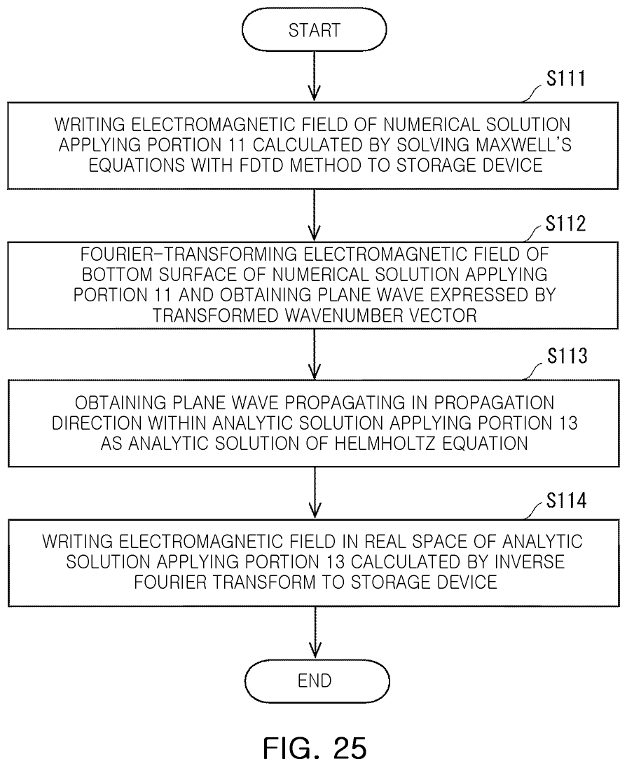

Next, as shown in step S111 of FIG. 25, the electromagnetic field of the numerical solution applying portion 11 obtained by numerically solving Maxwell's equations, such as with an FDTD method, etc., is written to the corresponding storage device STR. Next, as shown in step S112, the electromagnetic field of the connecting portion 12, which includes a bottom surface of the numerical solution applying portion 11, is Fourier-transformed, and a plane wave expressed by a transformed wavenumber vector is obtained.

Next, as shown in step S113, a plane wave that propagates in the propagation direction within the analytic solution applying portion 13 is obtained as an analytic solution of Helmholtz's equation. Next, as shown in step S114, the real space electromagnetic field obtained by calculating the analytic solution in the entire analytic solution applying portion 13 and inverse Fourier transforming the solution is written to the corresponding storage device STR.

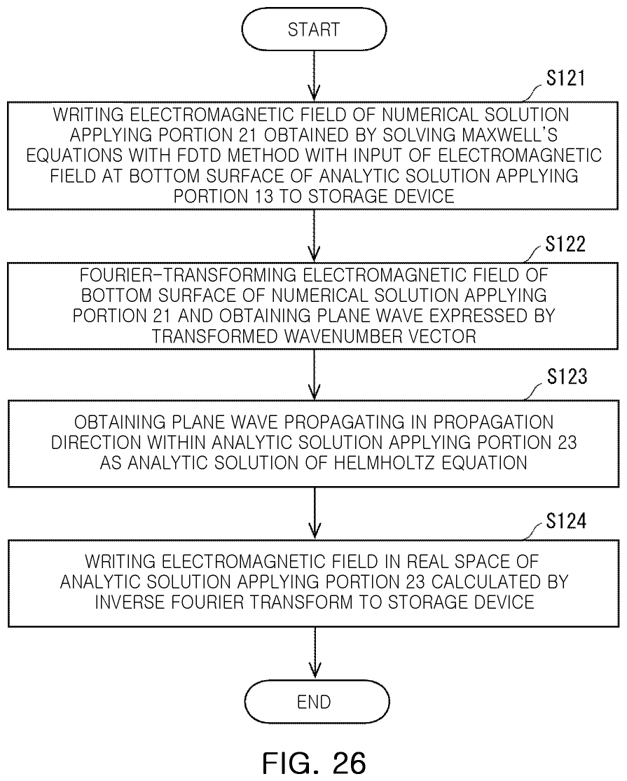

Next, as shown in step S121 of FIG. 26, the electromagnetic field obtained by numerically solving Maxwell's equations with an input of the electromagnetic field at the bottom surface of the analytic solution applying portion 13 is written to the corresponding storage device STR. Next, as shown in step S122, the electromagnetic field of the connecting portion 22 that includes the bottom surface of the numerical solution applying portion 21 is Fourier-transformed, and a plane wave expressed by the transformed wavenumber vector is obtained.

Next, as shown in step S123, a plane wave that propagates in the propagation direction within the analytic solution applying portion 23 is obtained as an analytic solution of Helmholtz's equation. Next, referring to step S124, the real space electromagnetic field obtained by calculating the analytic solution in the entire analytic solution applying portion 23 and inverse Fourier transforming the solution is written to the corresponding storage device STR.

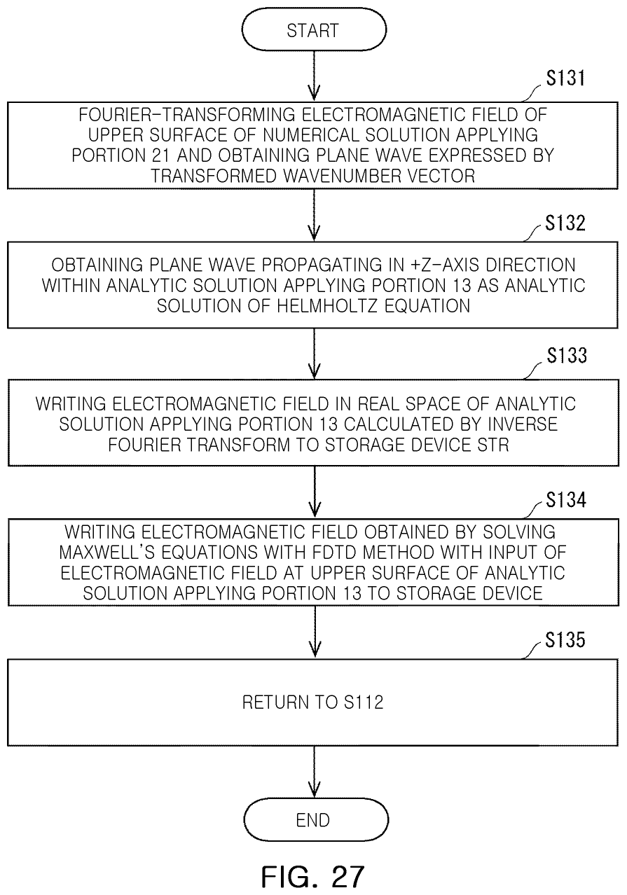

Next, as shown in step S131 of FIG. 27, the electromagnetic field of the portion that includes an upper surface of the numerical solution applying portion 21 is Fourier-transformed, and a plane wave expressed by the transformed wavenumber vector is obtained. Next, as shown in step S132, a plane wave that propagates in the +Z-axis direction within the analytic solution applying portion 13 is obtained as an analytic solution of Helmholtz's equation. Next, as shown in step S133, the real space electromagnetic field obtained by calculating the analytic solution in the entire analytic solution applying portion 13 and inverse Fourier transforming the solution is written to the corresponding storage device STR.

Next, as shown in step S134, the electromagnetic field obtained by numerically solving Maxwell's equations with an input of the electromagnetic field at the upper surface of the analytic solution applying portion 13 is written to the corresponding storage device STR. Next, as shown in step S135, the process returns to step S112. For example, the electromagnetic field of the bottom surface of the numerical solution applying portion 11 is Fourier-transformed, and a plane wave represented by the transformed wavenumber vector is obtained. Then, the real space electromagnetic field of the analytic solution applying portion 13 calculated by an inverse Fourier transform is written to the storage device STR.

By repeating the above process a specified number of times or until the stored electromagnetic field does not change, a result equivalent that of applying the numerical solution to the entire sample 30 is obtained. A steady state is obtained by continuing to update until the electromagnetic field converges. Based on this electromagnetic field, an absorbed energy, etc., is obtained.

For example, when a sample 30 has a plurality of numerical solution applying portions 11 and 21, a plurality of connecting portions 12 and 22, and a plurality of analytic solution applying portions 13 and 23, numerical calculations by the numerical solution are performed a plurality of times, due to multiple reflections. However, when the analytic solution applied portion 13 is sufficiently smaller than the numerical solution applied portion 11, etc., the electromagnetic field can be calculated in a shorter time than when the numerical solution is applied to the entire sample 30. Even when the sample 30 has three or more numerical solution applying portions and three or more analytic solution applying portions, the electromagnetic field can be calculated by a calculation method described above.

Embodiments of the present disclosure are not necessarily limited to embodiments described above, and appropriate changes are possible within a range without departing from a gist thereof. For example, each configuration of embodiments described above may be combined with each other. In addition, a following calculation program that causes a computer to read and execute a calculation method described above is also within the scope of the technical spirits of embodiments. A calculation program can be stored in a non-transitory computer readable medium or a tangible storage medium. For example, but not limitation, a computer readable medium or tangible storage medium includes at least one of a random-access memory (RAM), a read-only memory (ROM), a flash memory, a solid-state drive (SSD) or other memory technology, a CD-ROM, a ROM, a digital versatile disc (DVD), a Blu-ray® disk or other optical disk storage, a magnetic cassette, a magnetic tape, a magnetic disk storage or other magnetic storage device.

A calculation program that calculates an electromagnetic field of a sample is provided. and the calculation program causes a computer to divide a sample into a plurality of cells, where the sample has a numerical solution applying portion, a connecting portion and an analytic solution applying portion arranged sequentially in a propagation direction of incident light; and calculates the electromagnetic field of the sample by calculating an electromagnetic field of each cell based on a physical property value associated with the cell, where the incident light uniformly propagates in the propagation direction in the connecting portion and the analytic solution applying portion. When causing the computer to calculate the electromagnetic field of the sample, the calculation program causes the computer to: calculate the electromagnetic field of the numerical solution applying portion and the connecting portion by a numerical calculation that uses Maxwell's equations, transform the calculated electromagnetic field of the connecting portion into a plane wave expressed by a wavenumber vector by Fourier-transforming the calculated electromagnetic field of the connection portion, set the transformed plane wave of the connecting portion as an initial value and calculate the electromagnetic field in a wavenumber space of the analytic solution applying portion using Helmholtz's equation, when the plane wave propagates the analytic solution applying portion in the propagation direction, and calculate the electromagnetic field of the analytic solution applying portion by inverse Fourier-transforming the electromagnetic field in the wavenumber space of the calculated analytic solution applying portion.

When causing the computer to calculate the electromagnetic field of the sample, the calculation program may cause the computer to calculate one of an electric field, a magnetic field, or both the electric field and the magnetic field, depending on a predetermined purpose, in the analytic solution applying portion.

In addition, when causing the computer to calculate the electromagnetic field of the sample, the calculation program causes the computer to Fourier-transform two of the three components of the electromagnetic field, and calculates the remaining component from transverse wave conditions of electromagnetic waves, in the analytic solution applying portion.

When causing the computer to calculate the electromagnetic field of the sample, the calculation program may cause the computer to calculate the electromagnetic field in one of a first portion that includes a predetermined plane orthogonal to the propagation direction or a second portion sandwiched by two predetermined planes orthogonal to the propagation direction, in the analytic solution applying portion.

When causing the computer to divide the sample into the plurality of cells, the calculation program causes the computer to determine the numerical solution applying portion, the connecting portion and the analytic solution applying portion, by determining whether a complex refractive index of the cell is within a constant range in a direction opposite to the propagation direction.

When causing the computer to calculate the electromagnetic field of the sample, the calculation program causes the computer to calculate the electromagnetic field of the analytic solution applying portion by expanding the electromagnetic field in the connecting portion to the analytic solution applying portion by using a symmetric boundary condition and an anti-symmetric boundary condition.

The sample may comprise a plurality of the numeral solution applying portions and a plurality of the analytic solution applying portions, and the calculation program can further cause the computer to store data of the electromagnetic fields of the plurality of numeral solution applying portions and the plurality of analytic solution applying portions.

In the numeral solution applying portion and the analytic solution applying portion, a complex refractive index of the cell is within a constant range.

The sample may comprise a substrate and an element formed on the substrate, the analytic solution applying portion comprises the substrate, the numerical solution applying portion comprises the element, and the connecting portion comprises a portion in the substrate to which the element is connected.

The numerical calculation is at least one of an FDTD method, an FEM method, a BEM method, a CIP method, an FIT method, or a method of solving Maxwell's equations for a model in which a material is discretized with a grid.

While embodiments have been shown and described above, it will be apparent to those skilled in the art that modifications and variations could be made without departing from the scope of embodiments of the present inventive concept as defined by the appended claims.

What is claimed is:

1. A calculation device, comprising:
a calculation portion that divides a sample into a plurality of cells, and calculates an electromagnetic field of the sample by calculating an electromagnetic field of each cell based on a physical property value associated with the cell, wherein the sample includes a numerical solution applying portion, a connecting portion and an analytic solution applying portion that are sequentially arranged in a propagation direction of incident light,
wherein the calculation portion
calculates the electromagnetic field of the numerical solution applying portion and the connecting portion by a numerical calculation that uses Maxwell's equations,
Fourier transforms the calculated electromagnetic field of the connecting portion into a plane wave expressed by a wavenumber vector,
sets the plane wave of the connecting portion as an initial value, and calculates a wavenumber space electromagnetic field of the analytic solution applying portion by using Helmholtz's equation, when the plane wave propagates the analytic solution applying portion in the propagation direction, and
calculates the electromagnetic field of the analytic solution applying portion by inverse Fourier-transforming the wavenumber space electromagnetic field of the calculated analytic solution applying portion.

2. The calculation device of claim 1, wherein in the analytic solution applying portion, the calculation portion calculates one of an electric field, a magnetic field, or both the electric field and the magnetic field, depending on a predetermined purpose.

3. The calculation device of claim 1, wherein in the analytic solution applying portion, the calculation portion Fourier-transforms two of three components of the electromagnetic field, and calculates a remaining component from transverse wave conditions of electromagnetic waves.

4. The calculation device of claim 1, wherein in the analytic solution applying portion, the calculation portion calculates the electromagnetic field in one of a first portion that includes a predetermined plane orthogonal to the propagation direction or a second portion sandwiched by two predetermined planes orthogonal to the propagation direction.

5. The calculation device of claim 1, wherein the calculation portion determines the numerical solution applying portion, the connecting portion and the analytic solution applying portion, by determining whether a complex refractive index of the cell is within a constant range in a direction opposite to the propagation direction.

6. The calculation device of claim 1, wherein the calculation portion calculates the electromagnetic field of the analytic solution applying portion by expanding the electromagnetic field of the connecting portion into the analytic solution applying portion by using a symmetric boundary condition and an anti-symmetric boundary condition.

7. The calculation device of claim 1, wherein
the calculation device further comprises:
a storage device that stores data of the electromagnetic fields of a plurality of numeral solution applying portions and a plurality of analytic solution applying portions, for a sample that includes a plurality of the numeral solution applying portions and a plurality of the analytic solution applying portions.

8. The calculation device of claim 1, wherein in the numeral solution applying portion and the analytic solution applying portion, a complex refractive index of the cell is within a constant range.

9. The calculation device of claim 1, wherein, for a sample that includes a substrate and an element formed on the substrate, the calculation portion determines
the analytic solution applying portion as including the substrate,
the numerical solution applying portion as including the element, and
the connecting portion as including a portion in the substrate to which the element is connected.

10. The calculation device of claim 1, wherein the numerical calculation uses at least one of an FDTD method, an FEM method, a BEM method, a CIP method, an FIT method, or a method of solving Maxwell's equations for a model in which a material is discretized with a grid.

11. A calculation device for calculating an electromagnetic field of a sample having an analytic solution applying portion including a substrate, a numerical solution applying portion including at least one element, and a connecting portion including a portion in the substrate to which the at least one element is connected, comprising:
a calculation portion configured to divide each of the numerical solution applying portion, the connecting portion and the analytic solution applying portion into a plurality of cells,
wherein the calculation portion calculates the electromagnetic field of each of cells included in the numerical solution applying portion and the connecting portion by a numerical calculation that uses Maxwell's equations, and
wherein the calculation portion calculates the electromagnetic field of each of cells included in the analytic solution applying portion by an analytic solution that uses Helmholtz's equation.

12. The calculation device of claim 11, wherein the calculation portion calculates the electromagnetic field of each of the plurality of cells based on a physical property value associated with each of the plurality of cells.

13. The calculation device of claim 11, wherein the numerical calculation uses at least one of an FDTD method, an FEM method, a BEM method, a CIP method, an FIT method, or a method of solving Maxwell's equations for a model in which a material is discretized with a grid.

14. The calculation device of claim 11, wherein the calculation portion transforms the electromagnetic field of the connecting portion into a plane wave expressed by a wavenumber vector by Fourier-transforming the electromagnetic field of the connecting portion, and
the calculation portion calculates the analytic solution in wavenumber space by using Helmholtz's equation in which the plane wave of the connecting portion is set as an initial value.

15. The calculation device of claim 14, wherein the calculation portion calculates the electromagnetic field for each of the cells included in the analytic solution applying portion, by using the analytic solution in wavenumber space.

16. The calculation device of claim 15, wherein the calculation portion calculates the electromagnetic field for each of the cells included in the analytic solution applying portion, by inverse Fourier-transforming the analytic solution in wavenumber space.

17. The calculation device of claim 11, wherein the calculation portion determines a portion in which a complex refractive index is within a constant range as the analytic solution applying portion,
wherein the calculation portion determines a portion in which a complex refractive index is out of the constant range as the connecting portion, and
wherein the calculation portion determines a portion in a direction opposite to the connecting portion as the numerical solution applying portion.

18. The calculation device of claim 17, wherein the calculation portion determines the analytic solution applying portion, the connecting portion and the numerical solution applying portion in a direction opposite to a propagation direction of an incident light being incident on the sample.

19. The calculation device of claim 11, wherein, in the numerical solution applying portion, the calculation portion calculates the electromagnetic field of the numerical solution applying portion by using a symmetric boundary condition and an anti-symmetric boundary condition, when both a structure of the sample and an intensity of an incident light being incident on the sample are symmetric with respect to a propagation direction of the incident light.

20. The calculation device of claim 11, wherein, in the analytic solution applying portion, the calculation portion calculates the electromagnetic field of the analytic solution applying portion by dividing a plane perpendicular to a direction of a propagation of an incident light being incident on the sample into first to fourth quadrants and by inverting and copying an electromagnetic field calculated in the first quadrant.
